(19) United States
(12) Patent Application Publication
(10) Pub. No.: US 2013/0158992 A1
(43) Pub. Date: Jun. 20, 2013

(54) SPEECH PROCESSING SYSTEM AND METHOD

(71) Applicant: XI LIN, Shenzhen (CN)

(72) Inventor: XI LIN, Shenzhen (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/340,712

(22) Filed: Dec. 30, 2011

(30) Foreign Application Priority Data
Dec. 17, 2011 (CN) 201110426397.7

(51) Int. Cl. G10L 15/26

(52) U.S. Cl. 704/235; 704/E15.043

(57) ABSTRACT

An exemplary speech processing method includes extracting voice features from the stored audio files. Next, the method extracts speech(s) of a speaker from one or more audio files that contains voice feature matching one selected voice model, to form a single audio file, implements a speech-to-text algorithm to create a textual file based on the single audio file, and further records time point(s). The method then associates each of the words in the converted text with corresponding recorded time points recorded. Next, the method searches for an input keyword in the converted textual file. The method further obtains a time point associated with a word first appearing in the textual file that matches the keyword, and further controls an audio play device to play the single audio file at the determined time point.

### BACKGROUND

1. Technical Field

The present disclosure relates to speech processing systems and methods and, particularly, to a speech processing system capable of searching a keyword of a specific speaker in a speech signals and method.

2. Description of Related Art

Documenting a meeting through meeting minutes often plays an important part in organizational activities. Minutes can be used during a meeting to facilitate discussion and questions among the meeting participants. In the period shortly after the meeting, it may be useful to look at meeting minutes to review details and act on decisions. Meeting minutes can be recorded and be saved as a digital form. Sometimes, when attempting to find what one attendee said in the meeting, one may have to listen the entire digital meeting minutes, which is inconvenient.

### BRIEF DESCRIPTION OF THE DRAWINGS

The components of the drawings are not necessarily drawn to scale, the emphasis instead being placed upon clearly illustrating the principles of a voice recording device and a method thereof. Moreover, in the drawings, like reference numerals designate corresponding parts throughout several views.

FIG. 1 is a schematic diagram illustrating a speech processing device connected to an audio play device and an input device in accordance with an exemplary embodiment.

FIG. 2 is a block diagram of a speech processing method in accordance with an exemplary embodiment.

FIG. 3 is a flowchart of a speech processing method in accordance with an exemplary embodiment.

### DETAILED DESCRIPTION

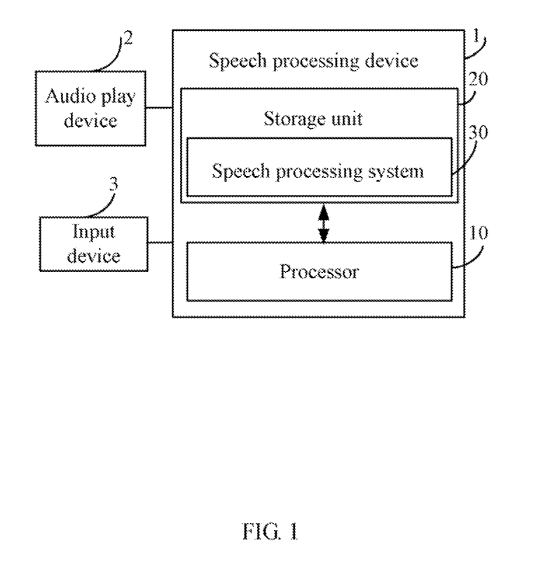

FIG. 1 shows a schematic diagram illustrating a speech processing device 1 connected to an audio play device 2 and an input device 3. The speech processing device 1 includes a processor 10, a storage unit 20, and a speech processing system 30. The speech processing system 30 is used to search audio contents of a specific speaker on a specific topic from the recorded audio files.

The storage unit 20 stores a speaker database and audio files. The speaker database records a number of voice models and personal information associated with each voice model. The voice models contain a set of characteristic parameters that represent the density of the speech feature vector values extracted from a number of voices. In the embodiment, the personal information associated with one voice model includes a user name, a picture of a user, for example. The audio files record what the speakers say in a meeting or a conference.

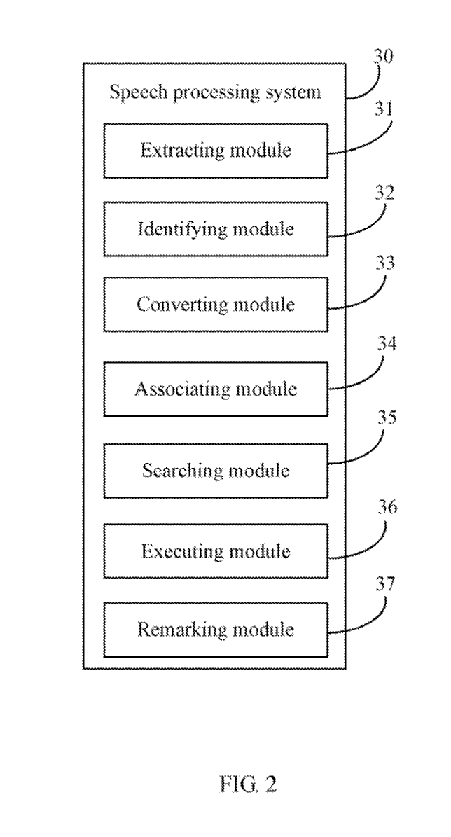

FIG. 2, in the embodiment, shows the speech processing system 30 includes an extracting module 31, an identifying module 32, a converting module 33, an associating module 34, a searching module 35, and an executing module 36. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of non transitory computer-readable medium or other storage device.

The extracting module 31 is used to extract speakers' voice features from the stored audio files. In the embodiment, the method to extract speaker's voice features is Mel-Frequency Cepstral Codfficient (MFCC) Method.

The identifying module 32 is used to determine whether one of the extracted voice features matches a selected voice model in response to a user operation of selecting one voice model from the stored voice models according to the personal information associated with the voice models.

When one of the extracted voice features matches the selected voice model, the converting module 33 extracts speech(s) of a specific speaker from one or more audio files to form a number of audio clips, and further combines the audio clips in sequence to form a single audio file. For example, in a stored audio file, a first speech of a specific speaker lasts from 5 minute 10 second to 15 minute 10 second, and a second speech of the specific speaker lasts from 22 minute 30 second to 25 minute 30 second. The converting module 33 extracts the first and the second speech to form a first audio clip with a 10-minute duration and a second audio clip with a 3-minute duration respectively. The converting module 33 combines the first audio clip and the second audio clip to form a single audio file with 13-minute duration. The converting module 33 can further implement a speech-to-text algorithm to create a textual file based on the single audio file. The converting module 33 also records the time point(s) each time when each word appears in the single audio file. For example, a word “innovative” appears three times in the single audio, the converting module 33 can record the time points when “innovative” appears.

The associating module 34 is used to associate each word in the converted textual file with corresponding time point(s) recorded by the converting module 33.

The searching module 35 is used to search for an input keyword in the converted textual file in response to a user operation of inputting the keyword.

When word(s) in the converted textual file match the input keyword, the executing module 36 obtains a time point associated with a word first appearing in the textual file that matches the keyword, and further controls the audio play device 2 to play the single audio file at the determined time point.

In the embodiment, the speech processing system 30 further includes a remarking module 37. The remarking module 37 is used to receive text input through the input device 3, convert the input text to a voice file, and further insert the converted voice file into the single audio file at a specific time point. Thus, a user can add a comment into the single audio signal. In other embodiment, the remarking module 37 can also add a comment into the stored audio files.

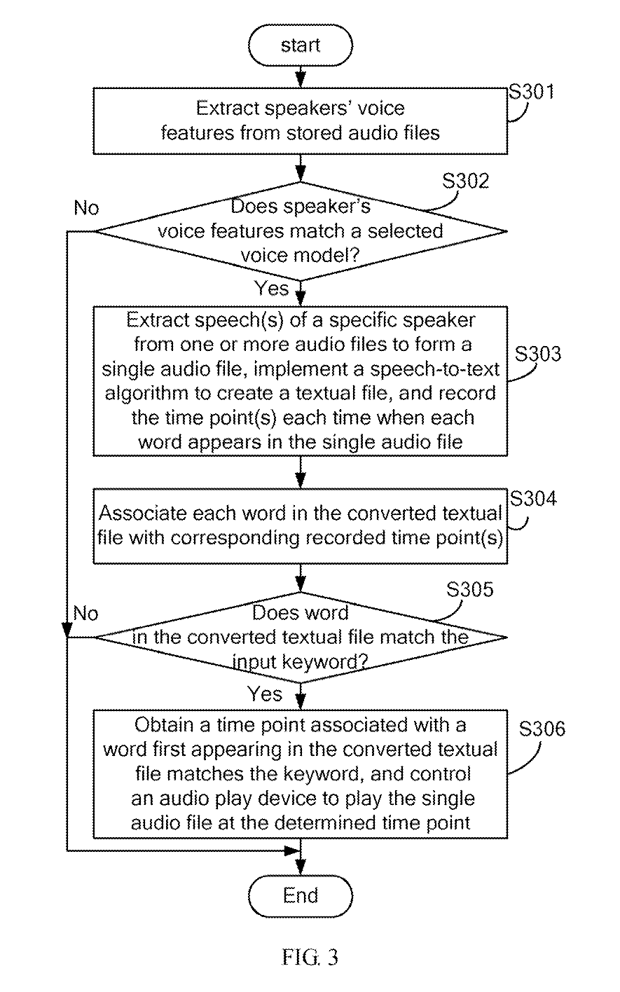

Referring to FIG. 3, a speech processing method in accordance with an exemplary embodiment is shown.

In step S301, the extracting module 31 extracts the voice feature from the stored audio files in response to user operation.

In step S302, the identifying module 32 determines whether one extracted voice feature matches a selected voice model in response to a user operation of selecting one voice model from the stored voice models. If one extracted voice feature matches the selected voice model, the procedure goes to step S303. If no extracted voice feature matches the selected voice model, the procedure ends.

In step S303, the converting module 33 extracts speech(s) of a specific speaker from one or more audio files to form a number of audio clips. In addition, combines the audio clips in sequence to form a single audio file, implements a speech-to text algorithm to create a textual file based on the single audio file, and records the time point(s) each time when each word appears in the single audio file.

In step S304, the associating module 34 associates each word in the converted textual file with corresponding time point(s) recorded by the converting module 33.

In step S305, the searching module 35 searches for a keyword in the converted textual file in response to a user operation of inputting the keyword. If word(s) in the converted textual file match the input keyword, the procedure goes to step S306. If no word in the converted textual file matches the input keyword, the procedure ends.

In step S306, the executing module 36 obtains a time point associated with a word first appearing in the converted textual file that matches the keyword, and further controls the audio play device 2 to play the single audio file at the determined time point.

In the embodiment, the step that the executing module 36 controls the audio play device 2 to play the single audio file is preformed before the remarking module 37 adds comment into the single audio file.

In detail, the remarking module 37 receives text input through the input device 3, converts the input text to a voice file, and further inserts the converted voice file into the single audio file at a specific time point.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A speech processing device comprising:
a storage unit storing a plurality of audio files, a plurality of voice models, and personal information associated with each of voice model;
a processor; and
one or more programs stored in the storage unit, to be executed by the processor, the one or more programs comprising:
an extracting module operable to extract voice features from the stored audio files in response to user operation;
an identifying module operable to determine whether one of the extracted voice features matches a selected voice model in response to a user operation of selecting the voice model from the stored voice models;
a converting module operable to:
extract speech(s) of a speaker from one or more audio files that contains voice feature matching the selected voice model, to form a single audio file;
implement a speech-to-text algorithm to create a textual file generated based on the single audio file; and
record time point(s) each time when each of words appears in the single audio file;
an associating module operable to associate each of the words in the converted textual file with a corresponding time point recorded by the converting module;
a searching module operable to search for an input keyword in the converted textual file in response to a user operation of inputting the keyword; and
an executing module operable to obtain a time point associated with a word first appearing in the textual file that matches the keyword, and further control an audio play device to play the single audio file at the determined time point.

2. The speech processing device as described in claim 1 further comprising a remarking module, wherein the remarking module is configured to: receive text inputted through an input device, convert the input text to a voice file, and further insert the converted voice file into the single audio file at a specific time point.

3. The speech processing device as described in claim 1, wherein the method to extract speaker's voice features is Mel-Frequency Cepstral Codfficient (MFCC) method.

4. A speech processing method implemented by the speech processing device, the speech processing device comprising a storage unit storing a plurality of audio files, a plurality of voice models, and personal information associated with each of voice model, the speech processing method comprising:
extracting voice features from the stored audio files in response to user operation;
determining whether one of the extracted speaker's voice features matches a selected voice model in response to a user operation of selecting one voice model from the stored voice models;
extracting speech(s) of a speaker from one or more audio files that contains voice feature matching the selected voice model, to form a single audio file, implementing a speech-to-text algorithm to create a textual file generated based on the single audio file; and recording time point(s) when one word appears in the single audio file for each word in the textual file;
associating each of the words in the converted text with corresponding recorded time points recorded;
searching for an input keyword in the converted textual file in response to a user operation of inputting the keyword; and
obtaining a time point associated with a word first appearing in the textual file that matches the keyword, and further controlling an audio play device to play the single audio file at the determined time point.

5. The speech processing method as described in claim 4, wherein the speech processing method further comprises:
receiving text inputted through an input device, converting the input text to a voice file, and further inserting the converted voice file into the single audio file at a specific time point.

6. The speech processing method as described in claim 4, wherein the method to extract speaker's voice features is Mel-Frequency Cepstral Codfficient (MFCC) method.

7. A storage medium storing a set of instructions, the set of instructions capable of being executed by a processor of a speech processing device, cause the speech processing device to perform a speech processing method, the method comprising:
extracting voice features from the stored audio files in response to user operation;
determining whether one of the extracted speaker's voice features matches a selected voice model in response to a user operation of selecting one voice model from the stored voice models;
extracting speech(s) of a speaker from one or more audio files that contains voice feature matching the selected voice model, to form a single audio file, implementing a speech-to text algorithm to create a textual file generated based on the single audio file, and recording time point(s) each time when each of words appears in the single audio file;
associating each of the word in the converted text with corresponding recorded time point;
searching for an input keyword in the converted textual file in response to a user operation of inputting the keyword; and
obtaining a time point associated with a word first appearing in the converted textual file that matches the keyword, and further controlling an audio play device to play the single audio file at the determined time point.

8. The storage medium as described in claim 7, wherein the method further comprises:
receiving text inputted through an input device, converting the input text to a voice file, and further inserting the converted voice file into the single audio signal at a specific time point.

9. The storage medium as described in claim 7, wherein the method to extract speaker's voice features is Mel-Frequency Cepstral Codfficient (MFCC) method.
